(19) United States
(12) Patent Application Publication
(10) Pub. No.: US 2026/0219962 A1
(43) Pub. Date: Jul. 30, 2026

(54) Ticket-Based Semaphores with Enhanced Waiting

(71) Applicant: Oracle International Corporation, Redwood City, CA (US)

(72) Inventors: David Dice, Foxboro, MA (US); Alex Kogan, Needham, MA (US)

(21) Appl. No.: 19/040,778

(22) Filed: Jan. 29, 2025

(51) Int. Cl. G06F 9/52

(52) U.S. Cl. CPC G06F 9/52

(57) ABSTRACT

A computer comprising one or more processors and memory may implement multiple threads that perform synchronization operations using a semaphore comprising an allocation field and a grant field. Upon entry to a semaphore wait operation, a thread allocates a ticket by atomically copying a ticket value contained in the allocation field and incrementing the allocation field. The thread computes a difference between the allocated ticket to the grant field representing a number of waiting threads. If the number is above the threshold, the thread enters a long term wait operation comprising determining a location for long term wait value and waiting on changes to that value. If the number is below the threshold or the long term wait operation is complete, the thread waits for the grant value to equal the ticket to complete waiting on the semaphore.

### BACKGROUND

### Field of the Disclosure

This disclosure relates generally to concurrent programming, and more particularly to systems and methods for performing concurrent synchronization using semaphores.

### Description of the Related Art

Modern computer systems conventionally include the ability to perform multiple threads of execution simultaneously, thus giving rise to the need to synchronize threads for access to shared data structures. Among these synchronization mechanisms is the semaphore, a widely used and foundational synchronization and coordination construct used for shared memory multithreaded programming. Furthermore, most other synchronization constructs, such as locks, mutexes and condition variables, may be implemented in terms of semaphores, although the converse is not generally true. Semaphores are also commonly used to build higher level primitives, such as thread pools, bounded buffers, producer-consumer patterns, reader-writer locks, message queues, and so on. Semaphores and the quality of their implementation are of consequence as they remain heavily used in modern operating system kernels and are also available for application programming via the pthreads programming interface, C++20, and Java's java.util.Concurrent.package. The Linux kernel also makes heavy internal use of semaphores.

### SUMMARY

Methods, techniques and systems for providing efficient ticket-based semaphores with improved allocation waiting are described. These various embodiments of ticket-based semaphores include the basic implementation of ticket semaphores, including a semaphore structure comprising ticket and grant fields and efficient operation during periods of no or low contention. The various embodiments of an enhanced ticket-based semaphores also include the addition of one or more secondary wait variables; when a thread executing an enhanced ticket-based semaphore operation determines that it must enter a long term waiting operation due to contention, it determines a wait location to monitor for indication of long term wait completion. In doing so, contention for the shared grant field of the semaphore is substantially reduced or eliminated. By reducing contention of the grant field, the enhanced ticket-based semaphore operation substantially improves the high contention scalability of semaphores while preserving the low contention performance and fairness.

### BRIEF DESCRIPTION OF THE DRAWINGS

FIG. 1 is a block diagram illustrating a system implementing a multithreaded application execution environment performing synchronization through the use of ticket-based semaphores, according to at least one embodiment.

FIG. 2 is a diagram illustrating a semaphore data structure used in at least one embodiment.

FIG. 3 is a flow diagram illustrating at least one embodiment of a method for implementing a signal operation using a ticket-based semaphore.

FIG. 4 is a flow diagram illustrating at least one embodiment of a method for implementing a wait operation using a ticket-based semaphore.

FIG. 5 is a diagram illustrating an ancillary semaphore data structure used in at least one embodiment.

FIG. 6 is a state diagram illustrating at least one embodiment of a method for implementing a ticket-based semaphore augmented with a wait array.

FIG. 7 is a flow diagram illustrating at least one embodiment of a method for implementing a wait operation using a ticket-based semaphore augmented with long term waiting.

FIG. 8 is a flow diagram illustrating at least one embodiment of a method for implementing a signal operation using a ticket-based semaphore augmented with long term waiting.

FIG. 9 is a diagram illustrating an ancillary semaphore data structure with an array of wait fields used in at least one embodiment.

FIG. 10 is a flow diagram illustrating at least one embodiment of a method for implementing a wait operation using a ticket-based semaphore augmented with an array of wait fields.

FIG. 11 is a flow diagram illustrating at least one embodiment of a method for implementing a signal operation using a ticket-based semaphore augmented with an array of wait fields.

FIG. 12 is a diagram illustrating ancillary semaphore data structures with an array of wait chains used in at least one embodiment.

FIG. 13 is a flow diagram illustrating at least one embodiment of a method for implementing a wait operation using a ticket-based semaphore augmented with an array of wait chains.

FIG. 14 is a flow diagram illustrating at least one embodiment of safely inserting an element into a wait chain.

FIG. 15 is a flow diagram illustrating at least one embodiment of a method for implementing a signal operation using a ticket-based semaphore augmented with an array of wait chains.

FIG. 16 is a block diagram illustrating one embodiment of a computing system that is configured to implement ticket-based semaphores, as described herein.

While the disclosure is described herein by way of example for several embodiments and illustrative drawings, those skilled in the art will recognize that the disclosure is not limited to embodiments or drawings described. It should be understood that the drawings and detailed description hereto are not intended to limit the disclosure to the particular form disclosed, but on the contrary, the disclosure is to cover all modifications, equivalents and alternatives falling within the spirit and scope as defined by the appended claims. Any headings used herein are for organizational purposes only and are not meant to limit the scope of the description or the claims. As used herein, the word “may” is used in a permissive sense (i.e., meaning having the potential to) rather than the mandatory sense (i.e. meaning must). Similarly, the words “include”, “including”, and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. § 112(f) interpretation for that unit/circuit/component.

This specification includes references to “one embodiment” or “an embodiment.” The appearances of the phrases “in one embodiment” or “in an embodiment” do not necessarily refer to the same embodiment, although embodiments that include any combination of the features are generally contemplated, unless expressly disclaimed herein. Particular features, structures, or characteristics may be combined in any suitable manner consistent with this disclosure.

### DETAILED DESCRIPTION OF EMBODIMENTS

Modern computer systems conventionally include the ability to perform multiple threads of execution simultaneously, thus giving rise to the need to synchronize threads for access to shared data structures. Among these synchronization mechanisms is the semaphore, a widely used and foundational synchronization and coordination construct used for shared memory multithreaded programming. Many other synchronization constructs, such as locks, mutexes and condition variables, may be implemented in terms of semaphores, although the converse is not generally true. Semaphores are also commonly used to build higher level primitives, such as thread pools, bounded buffers, producer-consumer patterns, reader-writer locks, messages queues, and so on. Semaphores and the quality of their implementation are of consequence as they remain heavily used in modern operating system kernels and are also available for application programming via the pthreads programming interface, C++20, and Java's java.util.Concurrent expose. The Linux kernel in particular makes heavy internal use of semaphores.

A computer comprising one or more processors and memory may implement multiple threads that perform synchronization operations using ticket-based semaphores comprising an allocation field and a grant field. Upon entry to a semaphore wait operation, a thread allocates a ticket by atomically copying a ticket value contained in the allocation field and incrementing the allocation field. The thread computes a difference between the allocated ticket to the grant field. representing a number of waiting threads. If the number is above the threshold, the thread enters a long term wait operation comprising determining a location for long term wait value and waiting on changes to that value. If the number is below the threshold or the long term wait operation is complete, the thread waits for the grant value to equal the ticket to complete waiting on the semaphore.

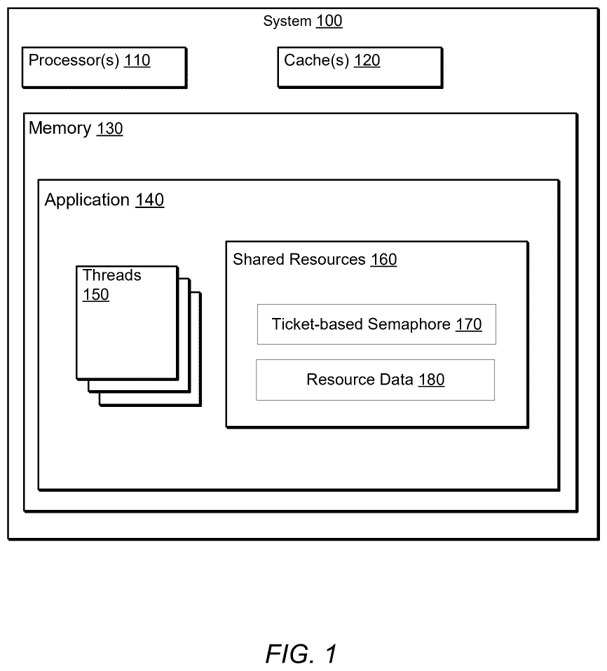

FIG. 1 is a block diagram illustrating a system implementing an application execution environment including multiple threads sharing a resource through the use of ticket-based semaphores. The System 100 includes one or more Processors 110 capable executing multiple parallel threads of execution coupled through one or more Caches 120 to a Memory 130 that includes an Application 140. The Application 140 may include multiple executing Threads 150 that access Shared Resources 160 including Resource Data 180 and Ticket-based Semaphore(s) 170 sharable by the Threads 150. In various embodiments, Threads 150 of Application 140 may perform synchronizations, such as to access resource data 180, using Ticket-based Semaphore(s) 170. While FIG. 1 shows a single application with three executing threads, this example is not intended to be limiting and any number of applications with any number of threads sharing any number of resources may be envisioned.

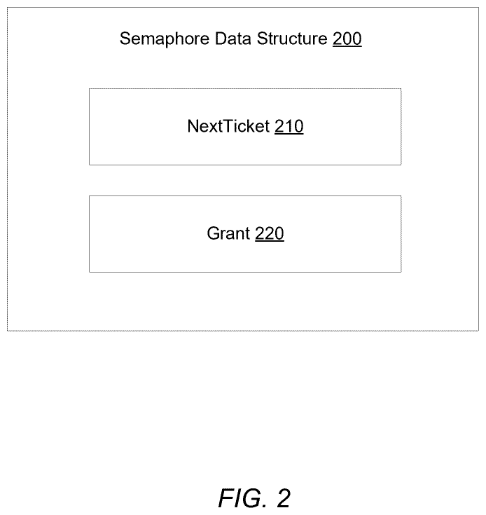

A ticket-based semaphore may be described by a semaphore data structure 200 as shown in FIG. 2, in at least one embodiment. This semaphore data structure 200 may include two integer fields, a NextTicket field 210 and a Grant field 220. Initially, these two fields will be assigned equal values, typically zero. When a thread waits for a semaphore, it may increment the NextTicket 210 field and assume a ticket value equal to the NextTicket field 210 before the increment operation. Once this occurs, the NextTicket field 210 contains a value higher than Grant field 220. When the thread desires to signal the semaphore, it may increment the Grant field 220. In this example, the NextTicket 210 and Grant 220 fields are monotonically increasing, except during integer overflows, by virtue of only being modified by increment operations. Therefore, differences between Grant and NextTicket may be reliable for determining semaphore wait completions given sufficiently high dynamic range integer representations, such as sixty four-bit integers as are common in modern processors. Those of ordinary skill in the art, however, will understand that this convention is only one of a number conventions that may be employed. For example, the NextTicket 210 and Grant 220 fields may each only be decremented resulting in monotonically decreasing values and ticket values less than or equal to the Grant field. Other conventions may also be employed and it should be understood that the conventions described above are not intended to be limiting.

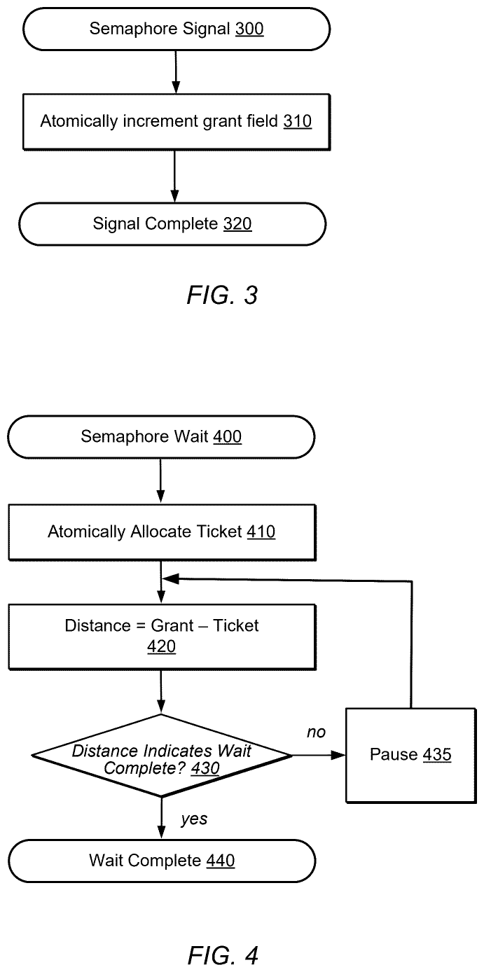

FIG. 3 is a flow diagram illustrating at least one embodiment of a method for implementing a signal operation 300 using a ticket-based semaphore. As shown in 310, a grant field of a desired semaphore, such as Grant 220 of FIG. 2, may be atomically incremented to signal the semaphore. Then, in at least one embodiment, the semaphore signaling is complete 320.

FIG. 4 is a flow diagram illustrating at least one embodiment of a method for implementing a wait operation using a ticket-based semaphore 400. As shown in 410, in at least one embodiment a thread which desires to wait for a semaphore may allocate a ticket defining a waiting position by performing an atomic increment operation, such as on a NextTicket field 310 as shown in FIG. 3, of the desired semaphore as discussed earlier in step 201 of Begin state 200 in FIG. 2. Then as shown in 420, in at least one embodiment a distance may be calculated 420 by subtracting the allocated ticket value from a grant value of the desired semaphore, such as the Grant 320 of FIG. 3. In such a calculation, a positive distance value may represent that a wait for the semaphore is complete. However, in at least one embodiment a distance may be calculated 420 by subtracting a grant value of the desired semaphore from the allocated ticket value where a negative distance value may represent that a wait for the semaphore is complete.

In at least one embodiment, if the computed distance indicates a wait for the desired semaphore is complete, as shown as a positive exit from 430, then the method may advance to 440 where the wait is complete. However, if the computed distance indicates a wait for the desired semaphore is not complete, as shown as a negative exit from 430, then the method may advance to 435 where a thread may optionally pause or yield before returning to step 420. In various embodiments, different approaches to yield may be employed by waiting threads. In at least one embodiment, no pause or yield may be employed, resulting in spinning, or busy-waiting, where threads simply loop, fetching (polling) and checking distances until the condition of interest is satisfied.

In at least one embodiment, spinning loops, however, may be decorated with a pause or yield instruction to inform that processor that a busy-waiting is active. Such instructions may act to cede resources to other processors, reduce thermal or energy consumption, and inform hypervisors (virtual machine monitors) that busy-waiting is in play to enable gang scheduling, if necessary. pause is considered an advisory “hint” to the system and has no specific semantics.

In at least one embodiment, waiting loops may also include calls to operating system services such as sched_yield, which hints to an operating system scheduler to transiently surrender the processor to other potentially runnable threads. The semantics of sched_yield are defined to be advisory and vague, providing considerable latitude to the implementation. As an example, a system may have two processors, with a thread one running on CPU-0 and thread two running on CPU-1. A thread three may be in ready state on a ready queue of CPU-0. If thread two calls sched_yield there is no guarantee that thread three will be scheduled onto CPU-1. Often, the call to sched_yield will return immediately if there are no ready threads on the caller's local ready queue. As such, sched_yield is not particularly helpful for spin loops.

While waiting, the spinning thread occupies a processor that might be otherwise used by other ready threads. As such, except for certain kernel environments, long-term unbounded spinning is disadvantageous.

If more runnable threads exist than processors, then involuntary preemption, as provided by the scheduler, may be problematic with respect to performance. For example, a system may have four processors and threads 1-4 may be dispatched for execution onto the processors and are busy-waiting for a lock held by thread 5 where thread 5 is runnable but has been preempted. To make forward progress, thread 5 should be scheduled via preemption of one of the other threads. Preemption, however, tends to operate in longer millisecond time frames, so throughput may be greatly impaired by using a pure spinning waiting strategy. In the context of ticket-based semaphores, spinning could be used both short-term spinning on the grant field or longer-term waiting via a waiting array.

In at least one embodiment, MONITOR-MWAIT on the x86 architecture, and similar facilities, such as WFE or WFET on ARM processors, offer a mode of waiting, potentially consuming less resources during polling, but still cause the waiting thread to occupy a processor. In at least one embodiment, once pausing or waiting 435 is complete, the method may return to 320.

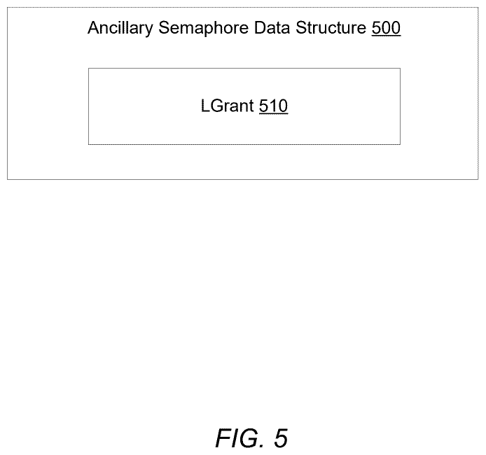

FIG. 5 is a diagram illustrating an ancillary semaphore data structure used in at least one embodiment. In at least one embodiment, an ancillary semaphore data structure 500 may be incorporated into a corresponding semaphore data structure, such as the semaphore data structure 300 of FIG. 3, while in other embodiments an ancillary semaphore data structure 500 may be maintained independently of a corresponding semaphore data structure. In at least one embodiment, ancillary semaphore data structure 500 may include a long-term grant, or LGrant integer field 510. LGrant 510 may be assigned a value equal to a value of a Grant field such as the Grant field 220 of FIG. 2 but reside in a memory local distinct from the Grant field such that contention for the Grant field may be diminished, in at least one embodiment.

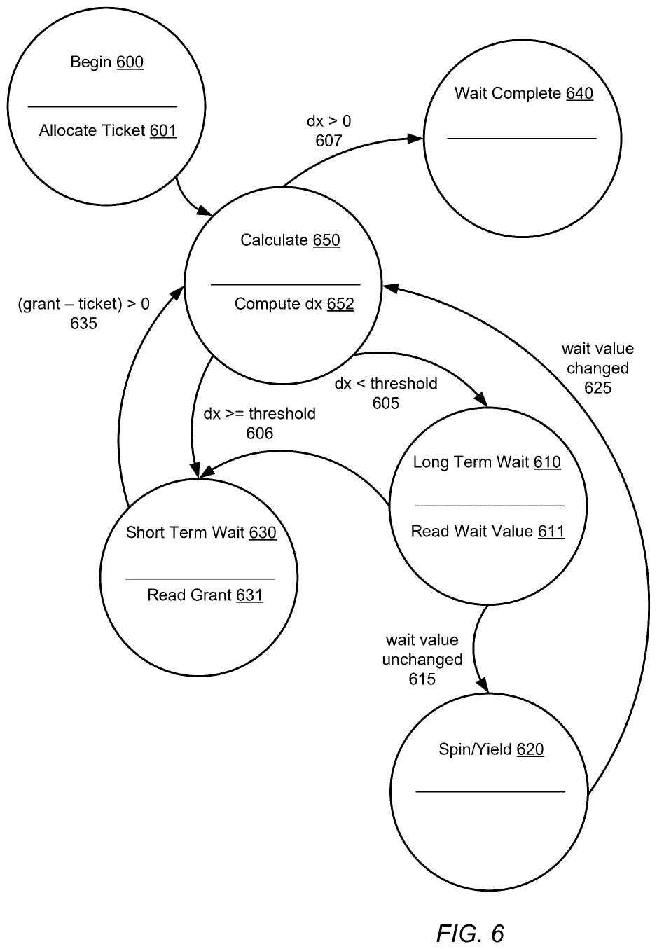

FIG. 6 is a state diagram illustrating an ticket-based semaphore operation according to some embodiments. A thread which desires to allocate a lock starts at the Begin state 600. In the Begin state 600, the thread first allocates a Ticket 601 by performing an atomic increment operation on a NextTicket field, such as NextTicket 210 of FIG. 2, for the desired semaphore. This may be performed using an atomic increment primitive, or instruction, that is a feature of many modern processor architectures. The atomic increment primitive loads the current value of a memory location, in this case the NextTicket field, increments the value contained in the memory location, and returns the value loaded which becomes the Ticket value for the thread. It should be understood, however, that an atomic increment primitive is not the only instruction usable to allocate the Ticket 601 and that any form of atomic update may also be used, particularly in computer architectures that don't directly provide an atomic increment primitive. Next, the operation may transition to a calculate state 650 where a distance, dx, is computed in step 652. This value is simply the allocated Ticket subtracted from the Grant field and is a signed value. If this value is positive (transition 607), then the thread has determined that a wait for the semaphore is complete and execution proceeds to the Wait Complete state 640.

If it is determined that the wait is not yet complete, then the distance dx may be compared to a predetermined threshold. If the distance is not below the threshold (transition 606), execution proceeds to Short Term Wait state 630. In the Short Term Wait state 630, the thread waits for the distance to become positive. Once a difference is greater than zero, (transition 635) execution returns to the Calculate state 650. If, however, the number of waiting threads is below the threshold (transition 605), execution proceeds to Long Term Wait state 610.

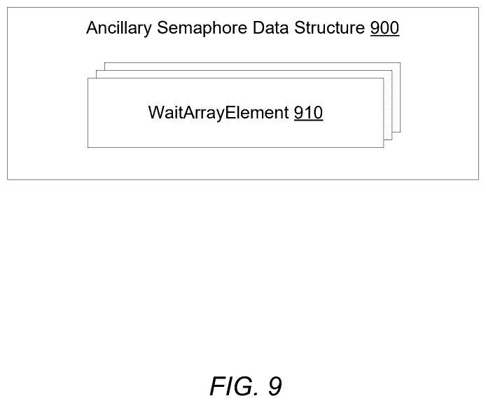

Once executing the Long Term Wait state 610, the thread first determines a memory location for a wait variable in step 611 on which to wait for completion of a long term wait operation. In at least one embodiment, a single long term wait value may be used, such as LGrant 510 of FIG. 5. In other embodiments, multiple long term wait values may be used such as discussed below in FIG. 9-14.

Once a long term wait variable is determined, an initial value of the long term wait variable is read in step 611. After this value is read, a distance, dx, is computed again in step 612 and, if the distance remains below the threshold (transition 615), execution proceeds to Spin or Yield state 620 where the thread waits for the long term wait variable value determined in step 611 and loaded in step 611 to change. In at least one embodiment, spinning loops, however, may be decorated with a pause or yield instruction to inform that processor that a busy-waiting is active. Such instructions may act to cede resources to other processors, reduce thermal or energy consumption, and inform hypervisors (virtual machine monitors) that busy-waiting is in play to enable gang scheduling, if necessary. pause is considered an advisory “hint” to the system and has no specific semantics.

In at least one embodiment, Spin or Yield state 620 may perform calls to operating system services such as sched_yield, which hints to an operating system scheduler to transiently surrender the processor to other potentially runnable threads. The semantics of sched_yield are defined to be advisory and vague, providing considerable latitude to the implementation. As an example, a system may have two processors, with a thread one running on CPU-0 and thread two running on CPU-1. A thread three may be in ready state on a ready queue of CPU-0. If thread two calls sched_yield there is no guarantee that thread three will be scheduled onto CPU-1. Often, the call to sched_yield will return immediately if there are no ready threads on the caller's local ready queue. As such, sched_yield is not particularly helpful for spin loops.

While waiting, the spinning thread occupies a processor that might be otherwise used by other ready threads. As such, except for certain kernel environments, long-term unbounded spinning is disadvantageous.

If more runnable threads exist than processors, then involuntary preemption, as provided by the scheduler, may be problematic with respect to performance. For example, a system may have four processors and threads 1-4 may be dispatched for execution onto the processors and are busy-waiting for a lock held by thread 5 where thread 5 is runnable but has been preempted. To make forward progress, thread 5 should be scheduled via preemption of one of the other threads. Preemption, however, tends to operate in longer millisecond time frames, so throughput may be greatly impaired by using a pure spinning waiting strategy. In the context of ticket-based semaphores, spinning could be used both short-term spinning on the grant field or longer-term waiting via a waiting array.

In at least one embodiment, MONITOR-MWAIT on the x86 architecture, and similar facilities, such as WFE or WFET on ARM processors, offer a mode of waiting, potentially consuming less resources during polling, but still cause the waiting thread to occupy a processor.

Once the long term wait value changes, execution returns 625 to the Calculate state 650. If, instead, the number of waiting threads is not below the threshold (transition 606), execution proceeds to Short Term Wait state 630. In the Short Term Wait state 630, the thread waits for the distance to become positive. Once a difference is greater than zero, (transition 635) execution returns to the Calculate state 650.

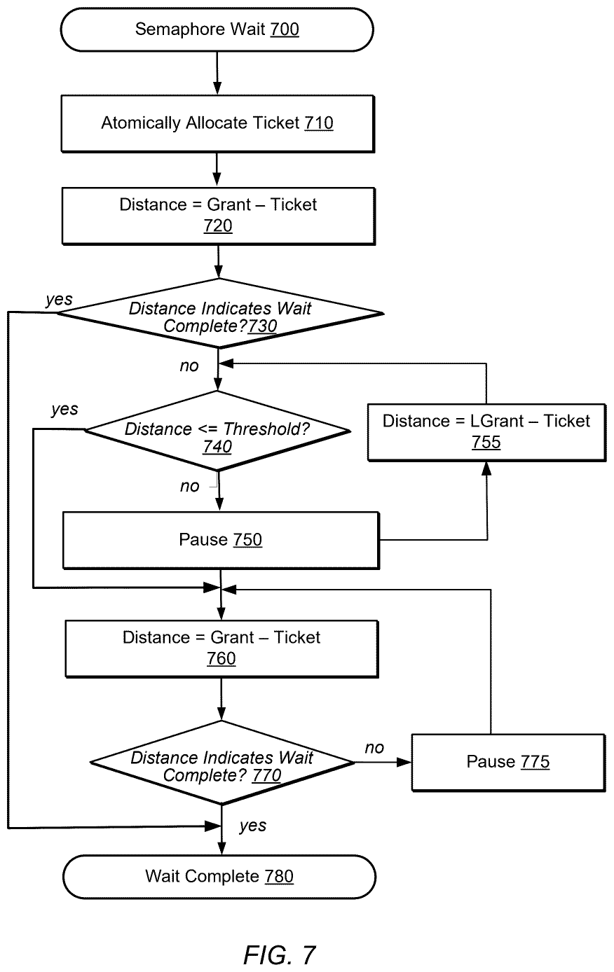

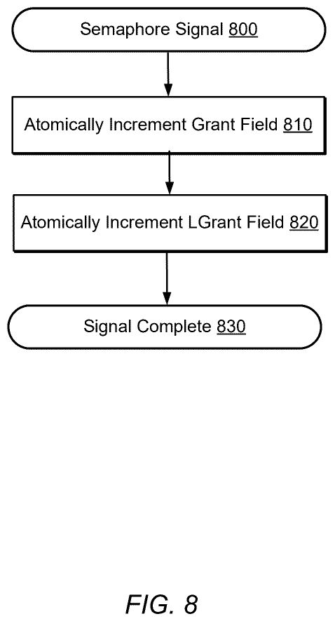

FIG. 7 is a flow diagram illustrating at least one embodiment of a method for implementing a wait operation using a ticket-based semaphore augmented with long term waiting 700. As shown in 710, in at least one embodiment a thread which desires to wait for a semaphore may allocate a ticket defining a waiting position by performing an atomic increment operation, such as on a NextTicket field 310 as shown in FIG. 3, of the desired semaphore as discussed earlier in step 201 of Begin state 200 in FIG. 2. Then as shown in 720, in at least one embodiment a distance may be calculated by subtracting the allocated ticket value from a grant value of the desired semaphore, such as the Grant 320 of FIG. 3. In such a calculation, a positive distance value may represent that a wait for the semaphore is complete. However, in at least one embodiment a distance may be calculated by subtracting a grant value of the desired semaphore from the allocated ticket value where a negative distance value may represent that a wait for the semaphore is complete.

In at least one embodiment, if the computed distance indicates a wait for the desired semaphore is complete, as shown as a positive exit from 730, then the method may advance to 780 where the wait is complete. However, if the computed distance indicates a wait for the desired semaphore is not complete, as shown as a negative exit from 730, then the method may advance to 740 where it may be determined whether a distance meets a threshold for a long term wait. In at least one embodiment, if the computed distance indicates that a threshold for long term wait is not met, as shown as a positive exit from 740, then the method may advance to 760. If, however, the computed distance indicates that a threshold for long term wait is met, as shown as a negative exit from 740, then the method may advance to 750.

In at least one embodiment, as shown in 750 a thread may optionally pause or yield before advancing to step 755. In various embodiments, different approaches to yield may be employed by waiting threads. In at least one embodiment, no pause or yield may be employed, resulting in spinning, or busy-waiting, where threads simply loop, fetching (polling) and checking distances until the condition of interest is satisfied.

In at least one embodiment, spinning loops, however, may be decorated with a pause or yield instruction to inform that processor that a busy-waiting is active. Such instructions may act to cede resources to other processors, reduce thermal or energy consumption, and inform hypervisors (virtual machine monitors) that busy-waiting is in play to enable gang scheduling, if necessary. pause is considered an advisory “hint” to the system and has no specific semantics.

In at least one embodiment, waiting loops may also include calls to operating system services such as sched_yield, which hints to an operating system scheduler to transiently surrender the processor to other potentially runnable threads. The semantics of sched_yield are defined to be advisory and vague, providing considerable latitude to the implementation. As an example, a system may have two processors, with a thread one running on CPU-0 and thread two running on CPU-1. A thread three may be in ready state on a ready queue of CPU-0. If thread two calls sched_yield there is no guarantee that thread three will be scheduled onto CPU-1. Often, the call to sched_yield will return immediately if there are no ready threads on the caller's local ready queue. As such, sched_yield is not particularly helpful for spin loops.

While waiting, the spinning thread occupies a processor that might be otherwise used by other ready threads. As such, except for certain kernel environments, long-term unbounded spinning is disadvantageous.

If more runnable threads exist than processors, then involuntary preemption, as provided by the scheduler, may be problematic with respect to performance. For example, a system may have four processors and threads 1-4 may be dispatched for execution onto the processors and are busy-waiting for a lock held by thread 5 where thread 5 is runnable but has been preempted. To make forward progress, thread 5 should be scheduled via preemption of one of the other threads. Preemption, however, tends to operate in longer millisecond time frames, so throughput may be greatly impaired by using a pure spinning waiting strategy. In the context of ticket-based semaphores, spinning could be used both short-term spinning on the grant field or longer-term waiting via a waiting array.

In at least one embodiment, MONITOR-MWAIT on the x86 architecture, and similar facilities, such as WFE or WFET on ARM processors, offer a mode of waiting, potentially consuming less resources during polling, but still cause the waiting thread to occupy a processor. In at least one embodiment, once pausing or waiting 750 is complete, the method may advance to 755.

In at least one embodiment, as shown in 755 a distance may be calculated by subtracting the allocated ticket value from an LGrant value of the desired semaphore, such as the LGrant 510 of FIG. 5. In such a calculation, a positive distance value may represent that a wait for the semaphore is complete. However, in at least one embodiment a distance may be calculated by subtracting a grant value of the desired semaphore from the allocated ticket value where a negative distance value may represent that a wait for the semaphore is complete. In at least one embodiment, the method may then return to 740.

In at least one embodiment, as shown in 760 a distance may be calculated by subtracting the allocated ticket value from a grant value of the desired semaphore, such as the Grant 320 of FIG. 3. In such a calculation, a positive distance value may represent that a wait for the semaphore is complete. However, in at least one embodiment a distance may be calculated by subtracting a grant value of the desired semaphore from the allocated ticket value where a negative distance value may represent that a wait for the semaphore is complete.

In at least one embodiment, if the computed distance indicates a wait for the desired semaphore is complete, as shown as a positive exit from 770, then the method may advance to 780 where the wait is complete. However, if the computed distance indicates a wait for the desired semaphore is not complete, as shown as a negative exit from 770, then the method may advance to 775 where a thread may optionally pause or yield before returning to step 760. In various embodiments, different approaches to yield may be employed by waiting threads. In at least one embodiment, no pause or yield may be employed, resulting in spinning, or busy-waiting, where threads simply loop, fetching (polling) and checking distances until the condition of interest is satisfied.

In at least one embodiment, spinning loops, however, may be decorated with a pause or yield instruction to inform that processor that a busy-waiting is active. Such instructions may act to cede resources to other processors, reduce thermal or energy consumption, and inform hypervisors (virtual machine monitors) that busy-waiting is in play to enable gang scheduling, if necessary. pause is considered an advisory “hint” to the system and has no specific semantics.

In at least one embodiment, waiting loops may also include calls to operating system services such as sched_yield, which hints to an operating system scheduler to transiently surrender the processor to other potentially runnable threads. The semantics of sched_yield are defined to be advisory and vague, providing considerable latitude to the implementation. As an example, a system may have two processors, with a thread one running on CPU-0 and thread two running on CPU-1. A thread three may be in ready state on a ready queue of CPU-0. If thread two calls sched_yield there is no guarantee that thread three will be scheduled onto CPU-1. Often, the call to sched_yield will return immediately if there are no ready threads on the caller's local ready queue. As such, sched_yield is not particularly helpful for spin loops.

While waiting, the spinning thread occupies a processor that might be otherwise used by other ready threads. As such, except for certain kernel environments, long-term unbounded spinning is disadvantageous.

If more runnable threads exist than processors, then involuntary preemption, as provided by the scheduler, may be problematic with respect to performance. For example, a system may have four processors and threads 1-4 may be dispatched for execution onto the processors and are busy-waiting for a lock held by thread 5 where thread 5 is runnable but has been preempted. To make forward progress, thread 5 should be scheduled via preemption of one of the other threads. Preemption, however, tends to operate in longer millisecond time frames, so throughput may be greatly impaired by using a pure spinning waiting strategy. In the context of ticket-based semaphores, spinning could be used both short-term spinning on the grant field or longer-term waiting via a waiting array.

In at least one embodiment, MONITOR-MWAIT on the x86 architecture, and similar facilities, such as WFE or WFET on ARM processors, offer a mode of waiting, potentially consuming less resources during polling, but still cause the waiting thread to occupy a processor. In at least one embodiment, once pausing or waiting 775 is complete, the method may return to 760.

FIG. 8 is a flow diagram illustrating at least one embodiment of a method for implementing a signal operation using a ticket-based semaphore augmented with long term waiting 800. In at least one embodiment, as shown in 810 a grant field of a desired semaphore, such as Grant 220 of FIG. 2, may be atomically incremented to signal the semaphore. In at least one embodiment, as shown in 820 an LGrant field of a desired semaphore, such as LGrant 510 of FIG. 5, may be atomically incremented to signal the semaphore. Then, in at least one embodiment, the semaphore signaling is complete 830.

FIG. 9 is a diagram illustrating an ancillary semaphore data structure with an array of wait fields used in at least one embodiment. In at least one embodiment, an ancillary semaphore data structure 900 may be incorporated into a corresponding semaphore data structure, such as the semaphore data structure 300 of FIG. 3, while in other embodiments an ancillary semaphore data structure 900 may be maintained independently of a corresponding semaphore data structure. In at least one embodiment, ancillary semaphore data structure 900 may include an array of long-term grant, or WaitArrayElement, integer fields 910. WaitArrayElement 910 may be assigned a value equal to a value of a Grant field such as the Grant field 220 of FIG. 2 but reside in a memory local distinct from the Grant field such that contention for the Grant field may be diminished, in at least one embodiment. In at least one embodiment, an array size of long-term grant values may be a tunable parameter, with a policy to set the array size proportional to a number of logical processors in the system. In at least one embodiment, alignment to may be employed to reduce the number of translation look-aside buffers (TLBs) underlying the array in order to reduce TLB misses. In at least one embodiment, the array may be placed in a large virtual memory page.

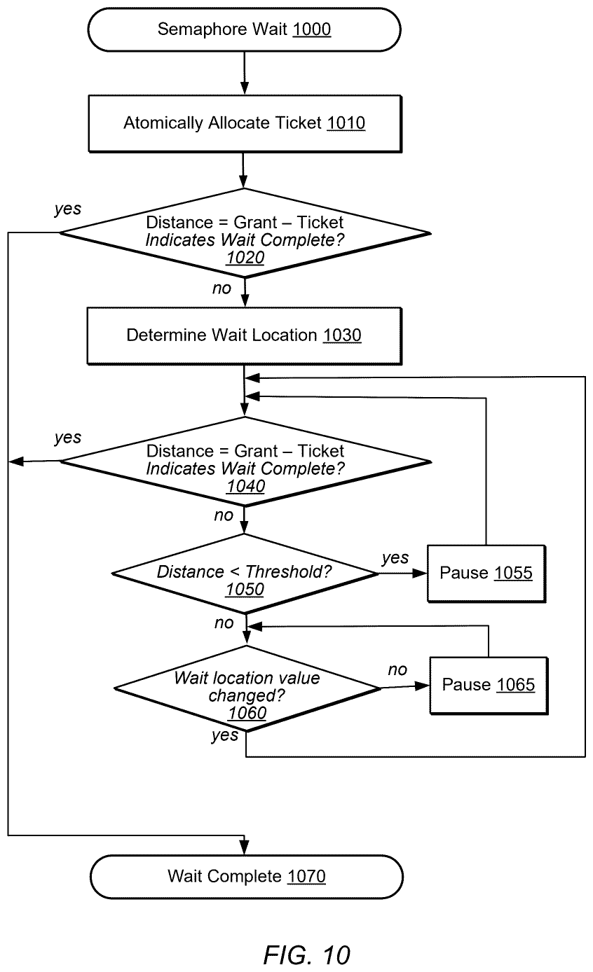

FIG. 10 is a flow diagram illustrating at least one embodiment of a method for implementing a wait operation using a ticket-based semaphore augmented with an array of wait fields 1000. As shown in 1010, in at least one embodiment a thread which desires to wait for a semaphore may allocate a ticket defining a waiting position by performing an atomic increment operation, such as on a NextTicket field 310 as shown in FIG. 3, of the desired semaphore as discussed earlier in step 201 of Begin state 200 in FIG. 2. Then as shown in 1020, in at least one embodiment a distance may be calculated by subtracting the allocated ticket value from a grant value of the desired semaphore, such as the Grant 320 of FIG. 3. In such a calculation, a positive distance value may represent that a wait for the semaphore is complete. However, in at least one embodiment a distance may be calculated by subtracting a grant value of the desired semaphore from the allocated ticket value where a negative distance value may represent that a wait for the semaphore is complete.

In at least one embodiment, if the computed distance indicates a wait for the desired semaphore is complete, as shown as a positive exit from 1020, then the method may advance to 1070 where the wait is complete. However, if the computed distance indicates a wait for the desired semaphore is not complete, as shown as a negative exit from 1020, then the method may advance to 1030 where a long term wait location may be determined. In at least one embodiment, this determination may be implemented by means of one or more hash operations to compute the effective element of one or more arrays of memory variables. The hash operation may be performed on the allocated ticket value, alone or in combination with other information related to the lock. In some embodiments, the hash may comprise simple modulo operations dependent on the sizes of the one or more waiting arrays with these modulo operations performed on the ticket value itself, alone or as modified by other lock information. In other embodiments, the ticket value may first be modified so as to enable the hash to distribute consecutive ticket values among unique cache lines. For example, the ticket value may first be scaled by a prime number selected to be close to the size of a cache line of the underlying computer architecture. Any number of hash computations or other determination technique may also be employed and it should be understood that the hash computations described above are not intended to be limiting. Furthermore, the determination of the wait variable may be performed on entry to Long Term Wait state 210 during the transition 205 rather than each time the Long Term Wait state is entered, thus reducing the number of computations required during the long term wait operation of the thread. In at least one embodiment, an array size of long-term grant values may be a tunable parameter, with a policy to set the array size proportional to a number of logical processors in the system. In at least one embodiment, alignment to may be employed to reduce the number of translation look-aside buffers (TLBs) underlying the array in order to reduce TLB misses. In at least one embodiment, the array may be placed in a large virtual memory page.

In at least one embodiment, as shown in 1040 a distance may be calculated by subtracting the allocated ticket value from a grant value of the desired semaphore, such as the Grant 320 of FIG. 3. In such a calculation, a positive distance value may represent that a wait for the semaphore is complete. However, in at least one embodiment a distance may be calculated by subtracting a grant value of the desired semaphore from the allocated ticket value where a negative distance value may represent that a wait for the semaphore is complete.

In at least one embodiment, if the computed distance indicates a wait for the desired semaphore is complete, as shown as a positive exit from 1040, then the method may advance to 1070 where the wait is complete. However, if the computed distance indicates a wait for the desired semaphore is not complete, as shown as a negative exit from 1040, then the method may advance to 1050 where a thread may determine whether a distance meets a threshold for a long term wait. In at least one embodiment, if the computed distance indicates that a threshold for long term wait is not met, as shown as a positive exit from 1050, then the method may advance to 1055. If, however, the computed distance indicates that a threshold for long term wait is met, as shown as a negative exit from 1050, then the method may advance to 1060.

In at least one embodiment, as shown in 1055, a thread may optionally pause or yield before returning to step 1040. In various embodiments, different approaches to yield may be employed by waiting threads. In at least one embodiment, no pause or yield may be employed, resulting in spinning, or busy-waiting, where threads simply loop, fetching (polling) and checking distances until the condition of interest is satisfied.

In at least one embodiment, spinning loops, however, may be decorated with a pause or yield instruction to inform that processor that a busy-waiting is active. Such instructions may act to cede resources to other processors, reduce thermal or energy consumption, and inform hypervisors (virtual machine monitors) that busy-waiting is in play to enable gang scheduling, if necessary. pause is considered an advisory “hint” to the system and has no specific semantics.

In at least one embodiment, waiting loops may also include calls to operating system services such as sched_yield, which hints to an operating system scheduler to transiently surrender the processor to other potentially runnable threads. The semantics of sched_yield are defined to be advisory and vague, providing considerable latitude to the implementation. As an example, a system may have two processors, with a thread one running on CPU-0 and thread two running on CPU-1. A thread three may be in ready state on a ready queue of CPU-0. If thread two calls sched_yield there is no guarantee that thread three will be scheduled onto CPU-1. Often, the call to sched_yield will return immediately if there are no ready threads on the caller's local ready queue. As such, sched_yield is not particularly helpful for spin loops.

While waiting, the spinning thread occupies a processor that might be otherwise used by other ready threads. As such, except for certain kernel environments, long-term unbounded spinning is disadvantageous.

If more runnable threads exist than processors, then involuntary preemption, as provided by the scheduler, may be problematic with respect to performance. For example, a system may have four processors and threads 1-4 may be dispatched for execution onto the processors and are busy-waiting for a lock held by thread 5 where thread 5 is runnable but has been preempted. To make forward progress, thread 5 should be scheduled via preemption of one of the other threads. Preemption, however, tends to operate in longer millisecond time frames, so throughput may be greatly impaired by using a pure spinning waiting strategy. In the context of ticket-based semaphores, spinning could be used both short-term spinning on the grant field or longer-term waiting via a waiting array.

In at least one embodiment, MONITOR-MWAIT on the x86 architecture, and similar facilities, such as WFE or WFET on ARM processors, offer a mode of waiting, potentially consuming less resources during polling, but still cause the waiting thread to occupy a processor. In at least one embodiment, once pausing or waiting 750 is complete, the method may return to 1040.

In at least one embodiment, as shown in 1060, a thread may determine if a value at the wait location determined in 1030 has changed since a last reading. In at least one embodiment, if the value has changed, as shown as a positive exit from 1060, then the method may return to 1030. However, if the value has not changed, as shown as a negative exit from 1060, then the method may advance to 1065 where a thread may optionally pause or yield, such as discussed above in step 1055, before returning to step 1060. In various embodiments, different approaches to pause or yield may be employed by waiting threads. In at least one embodiment, no pause or yield may be employed, resulting in spinning, or busy-waiting, where threads simply loop, fetching (polling) and checking distances until the condition of interest is satisfied. It should be understood that different methods of pausing or yielding may be employed in steps 1055 and 1065, in various embodiments.

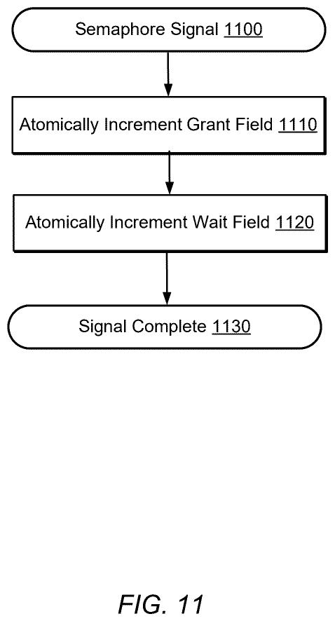

FIG. 11 is a flow diagram illustrating at least one embodiment of a method for implementing a signal operation using a ticket-based semaphore augmented with an array of wait fields 1100. In at least one embodiment, as shown in 1110 a wait field of a desired semaphore, such as Grant 220 of FIG. 2, may be atomically incremented to signal the semaphore. In at least one embodiment, as shown in 1120 a wait field of a desired semaphore, such as LGrant 510 of FIG. 5, may be atomically incremented to signal the semaphore.

In at least one embodiment, a long term wait location may first be determined. In at least one embodiment, this determination may be implemented by means of one or more hash operations to compute the effective element of one or more arrays of memory variables. The hash operation may be performed on the allocated ticket value, alone or in combination with other information related to the lock. In some embodiments, the hash may comprise simple modulo operations dependent on the sizes of the one or more waiting arrays with these modulo operations performed on the ticket value itself, alone or as modified by other lock information. In other embodiments, the ticket value may first be modified so as to enable the hash to distribute consecutive ticket values among unique cache lines. For example, the ticket value may first be scaled by a prime number selected to be close to the size of a cache line of the underlying computer architecture. Any number of hash computations or other determination technique may also be employed and it should be understood that the hash computations described above are not intended to be limiting. In at least one embodiment, once a long term wait location has been determined, the location may be atomically incremented to signal the semaphore. Then, in at least one embodiment, the semaphore signaling is complete 1130.

In at least one embodiment, a spin-the-block spin-then-park waiting via a park-unpark interface may enable threads to wait politely in an operating system kernel, surrendering processor execution to other ready or runnable threads. Specifically, to use park-unpark, a single waiting array slot may be mapped to a set of waiting threads, as the park-unpark interface needs to be able wake specific threads by their identity or associated address. To accomplish this, elements in a WaitArray, such as WaitArrayElement 910 as shown in FIG. 9, may be pointers to a head of a stack or chain of waiting threads instead of a modification counters as used in FIGS. 10 and 11 above. Arriving threads push themselves onto a chain with an atomic exchange (SWAP). The list of waiting threads on a given chain is implicit. In at least one embodiment, a thread knows the identity (address) of its successor in the chain, but nothing more. There is no need for “next” pointers, for instance Once a thread has pushed its “WaitElement” onto a chain, it then busy-waits (or parks) on a “Gate” field within that WaitElement. WaitElements may be allocated on-stack which much simplifies the design and removes memory management and lifecycle issues.

In at least one embodiment, to notify and wake threads an entire chain may be detached with an exchange( ) operation followed by activation of the first thread in the chain. That thread may, in turn, activate its successor, and so on, to make sure all detached elements are made awake so they can recheck their respective conditions of interest. Hash collision may result in multiple threads placed on a given chain, thus admits spurious wakeups may occur. Either the waiting primitives or their caller must reevaluate the condition before determining the wait is satisfied, in various embodiments.

In at least one embodiment, a Linux Kernel Futex mechanism allows threads to designate an address of interest and then block in the kernel, surrendering the processor and allowing other threads to immediately use the processor, until some other thread performs a corresponding notification system call on that same address. Microsoft Windows exposes a similar WaitOnAddress mechanism. The underlying futex implementation hashes the specified virtual address into an index into a kernel hash table, where each bucket contains a spinlock and a pointer to a linked list of threads waiting on that bucket. In at least one embodiment, a spin lock is used to protect that specific bucket. In the context of ticket-based semaphores, futex services may be utilized to wait on the buckets in a waiting array. This approach confers an additional scalability advantage. As the futex operator hashes address into kernel hashtable buckets, by using multiple address in the waiting array futex operations may be dispersed over the entire futex hashtable, avoiding hot spots and reducing contention on individual per-bucket futex hash table spinlocks.

In at least one embodiment, threads deeper on the logical queue than threshold may wait via futex while those closer to the front spin. Alternatively, all threads in at least one embodiment may wait by futex to eliminate all spinning. In other embodiments, a hybrid spin-then-park waiting strategy may be employed where threads would attempt a brief bounded local spinning phase followed, if necessary, by park.

In at least one embodiment, some low-level waiting primitives, such as park-unpark, allow a thread to park which de-schedules the calling thread until a corresponding unpark. Again, this allows the CPU of thread calling park to be reallocated and dispatched onto immediately, allowing other ready threads to start running. If the unpark were to execute before the corresponding park, the threading system maintains a per-thread flag set accordingly, and the subsequent park operation clears the flag and returns immediately. Park-unpark can thus be considered to provide a bounded binary per-thread semaphore. park-unpark is a 1:1 point-to-point model, in that the unpark operator must know and pass the identity of the specific thread to be unparked, and unpark wakes just that one thread. We observed that park-unpark is identity-based while the futex operator is address-based.

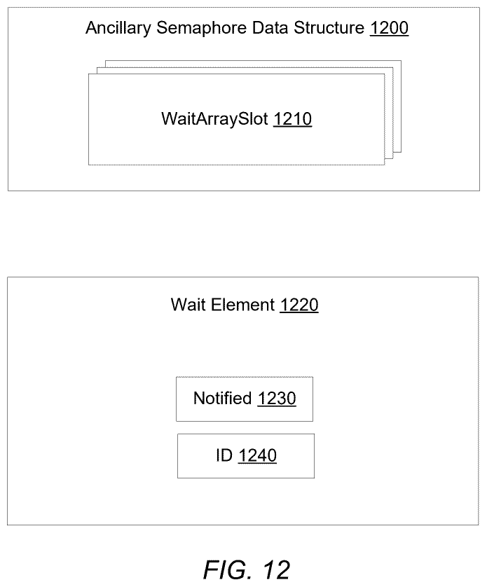

FIG. 12 is a diagram illustrating ancillary semaphore data structures with an array of wait chains used in at least one embodiment. In at least one embodiment, an ancillary semaphore data structure 1200 may be incorporated into a corresponding semaphore data structure, such as the semaphore data structure 300 of FIG. 3, while in other embodiments an ancillary semaphore data structure 1200 may be maintained independently of a corresponding semaphore data structure. In at least one embodiment, ancillary semaphore data structure 1200 may include an array of WaitArraySlots 1210, where each slot includes a head pointer for a wait chain, if a wait chain exists. In at least one embodiment, a wait chain may be an explicitly or implicitly linked list of wait elements, where each element may be implemented as a Wait Element 1220. In at least one embodiment, a Wait Element 1220 may include a Notified field 1230 which contains a Boolean value indicating of the element has been notified to awaken. In at least one embodiment, a Wait Element 1220 may also include an identifier, or ID, 1240 that uniquely identifies a thread associated with the wait element. In various embodiments, a Wait Element 1220 may additionally include various fields to maintain linked lists of a wait chain (not shown).

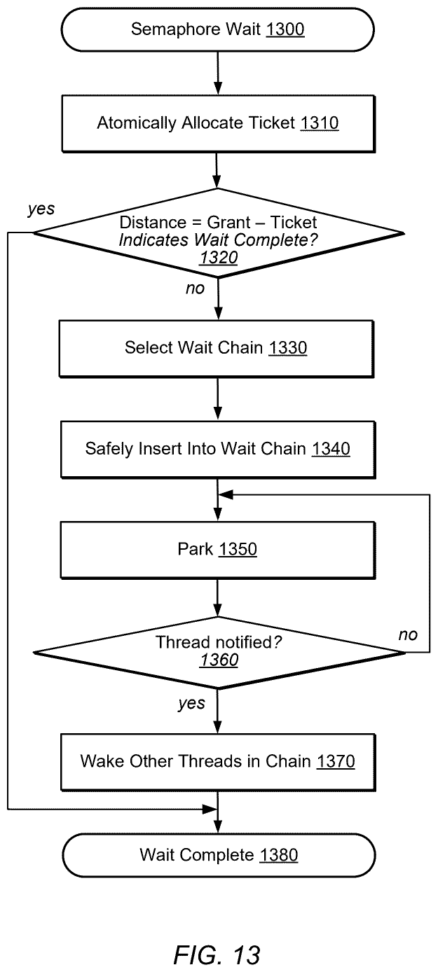

FIG. 13 is a flow diagram illustrating at least one embodiment of a method for implementing a wait operation using a ticket-based semaphore augmented with an array of wait chains. As shown in 1310, in at least one embodiment a thread which desires to wait for a semaphore may allocate a ticket defining a waiting position by performing an atomic increment operation, such as on a NextTicket field 310 as shown in FIG. 3, of the desired semaphore as discussed earlier in step 201 of Begin state 200 in FIG. 2. Then as shown in 1020, in at least one embodiment a distance may be calculated by subtracting the allocated ticket value from a grant value of the desired semaphore, such as the Grant 320 of FIG. 3. In such a calculation, a positive distance value may represent that a wait for the semaphore is complete. However, in at least one embodiment a distance may be calculated by subtracting a grant value of the desired semaphore from the allocated ticket value where a negative distance value may represent that a wait for the semaphore is complete.

In at least one embodiment, as shown in 1320 a distance may be calculated by subtracting the allocated ticket value from a grant value of the desired semaphore, such as the Grant 320 of FIG. 3. In such a calculation, a positive distance value may represent that a wait for the semaphore is complete. However, in at least one embodiment a distance may be calculated by subtracting a grant value of the desired semaphore from the allocated ticket value where a negative distance value may represent that a wait for the semaphore is complete. In at least one embodiment, if the computed distance indicates a wait for the desired semaphore is complete, as shown as a positive exit from 1320, then the method may advance to 1380 where the wait is complete. However, if the computed distance indicates a wait for the desired semaphore is not complete, as shown as a negative exit from 1320, then the method may advance to 1330 where a wait chain may be selected for insertion. To select a wait chain, in at least one embodiment one or more hash operations may be used to compute an effective element, such as a Wait Element 1220 identified by a WaitArraySlot 1210 as shown in FIG. 12, of one or more arrays of memory variables. The hash operation may be performed on the allocated ticket value, alone or in combination with other information related to the lock. In some embodiments, the hash may comprise simple modulo operations dependent on the sizes of the one or more waiting arrays with these modulo operations performed on the ticket value itself, alone or as modified by other lock information. In other embodiments, the ticket value may first be modified so as to enable the hash to distribute consecutive ticket values among unique cache lines. For example, the ticket value may first be scaled by a prime number selected to be close to the size of a cache line of the underlying computer architecture. Any number of hash computations or other determination technique may also be employed and it should be understood that the hash computations described above are not intended to be limiting.

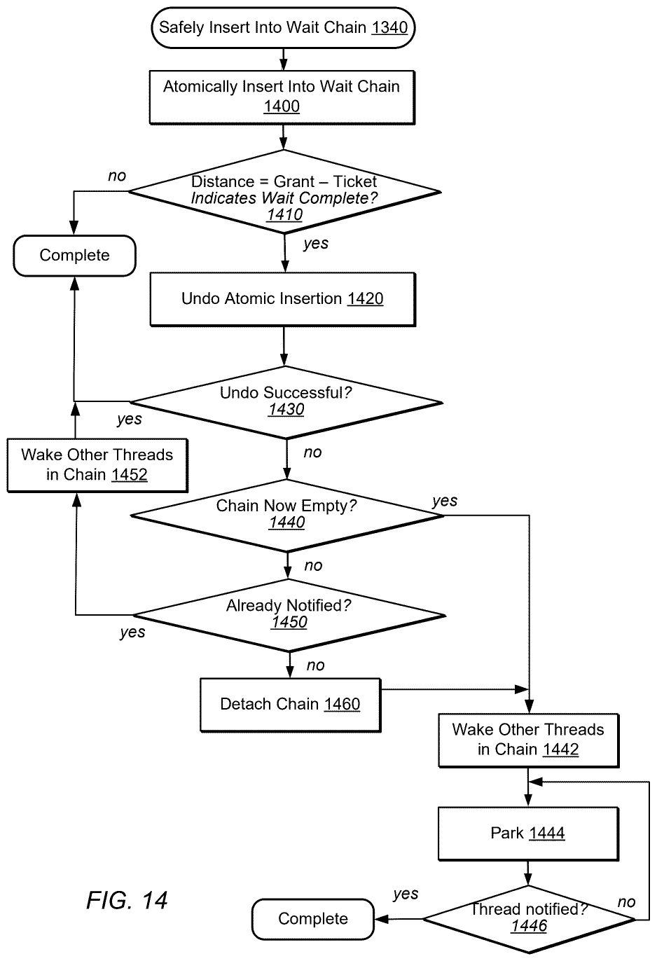

In at least one embodiment, a thread may then safely insert itself into the wait chain by using a Wait Element, such as a Wait Element 1220 as shown in FIG. 12. Details of this insertion process are discussed below in FIG. 14.

Then, in at least one embodiment, a thread may call an operating system service to park the thread 1350. Alternatively, in at least one embodiment a thread may, in lieu of parking, a thread may pause or yield, where different approaches to yield may be employed by waiting threads. Pausing or yielding is discussed in greater detail above in FIGS. 4, 7 and 10.

In at least one embodiment, a thread, upon awakening from a park or yield operation, may check a Boolean field, such as the Notified field 1230 of FIG. 12, to determine if the thread has been notified to terminate a wait operation. In at least one embodiment, if the thread has been notified, as shown as a positive exit from 1360, then the method may advance to 1370. However, if the thread has not been notified, as shown as a negative exit from 1360, then the method may return to 1350.

In at least one embodiment, as shown in 1370 a thread may then signal other threads in the wait chain to awaken using an explicit or implicit linked list. The wait is then complete, as shown in 1380.

FIG. 14 is a flow diagram illustrating at least one embodiment of safely inserting an element into a wait chain. In at least one embodiment, a waiting thread may use an atomic exchange operator to push a Waiting Element address, such as an address of a Waiting Element 1220 of FIG. 12, onto the stack or linked list 1400. In at least one embodiment, a waiting element may be allocated on a thread stack and require no special memory management considerations. The waiting element may contain a Boolean flag indicating a notified status and the identity of the associated thread, as discussed above in FIG. 12. To notify long-term waiters at a particular index, an atomic exchange may be used to detach the entire chain and then unpark all the threads on the chain, allowing them the opportunity to reevaluate their corresponding grant values to see if the wait condition has been satisfied. Management of such chains is completely lock-free.

In at least one embodiment, as shown in 1410, a distance may be calculated by subtracting the allocated ticket value from a grant value of the desired semaphore, such as the Grant 320 of FIG. 3. In such a calculation, a positive distance value may represent that a wait for the semaphore is complete. However, in at least one embodiment a distance may be calculated by subtracting a grant value of the desired semaphore from the allocated ticket value where a negative distance value may represent that a wait for the semaphore is complete. In at least one embodiment, if the computed distance indicates a wait for the desired semaphore is complete, as shown as a positive exit from 1410, then the method may advance to 1420. However, if the computed distance indicates a wait for the desired semaphore is not complete, as shown as a negative exit from 1410, then the method is complete.

In at least one embodiment, as shown in 1420, a thread may attempt to undo atomic insertion of step 1400 using an atomic operation such as a compare and swap instruction. In at least one embodiment, if the undo operation does not succeed, as shown as a negative exit from 1430, then the method may advance to 1440. However, if the undo operation succeeds, as shown as a positive exit from 1430, then the method is complete.

In at least one embodiment, as shown in 1440, a result of the undo operation may indicate that a wait chain is now empty. In at least one embodiment, if the wait chain is not empty, as shown as a negative exit from 1440, then the method may advance to 1450. However, if the wait chain is empty, as shown as a positive exit from 1440, then the method may advance to 1442.

In at least one embodiment, as shown in 1450, a thread may determine if it has already been notified that its wait is complete. In at least one embodiment, if the thread has been notified, as shown as a positive exit from 1450, then the method may advance to 1452. However, if the thread has not been notified, as shown as a negative exit from 1450, then the method may advance to 1460.

In at least one embodiment, as shown in 1452 the thread may wake other threads in the chain by asserting, or writing a true value to, a notify field, such as the Notified field 1230 as shown in FIG. 12, to a first element in the chain. Then the method is complete.

In at least one embodiment, as shown in 1460 the thread may then detach the wait chain using an atomic operation. The method may then advance to 1442.

In at least one embodiment, as shown in 1442 the thread may wake other threads in the chain by asserting, or writing a true value to, a notify field, such as the Notified field 1230 as shown in FIG. 12, to a first element in the chain. Then, in at least one embodiment, a thread may call an operating system service to park the thread 1444. Alternatively, in at least one embodiment a thread may, in lieu of parking, a thread may pause or yield, where different approaches to yield may be employed by waiting threads. Pausing or yielding is discussed in greater detail above in FIGS. 4, 7 and 10.

In at least one embodiment, a thread, upon awakening from a park or yield operation, may check a Boolean field, such as the Notified field 1230 of FIG. 12, to determine if the thread has been notified to terminate a wait operation. In at least one embodiment, if the thread has been notified, as shown as a positive exit from 1446, then the method is complete 70. However, if the thread has not been notified, as shown as a negative exit from 1446, then the method may return to 1444.

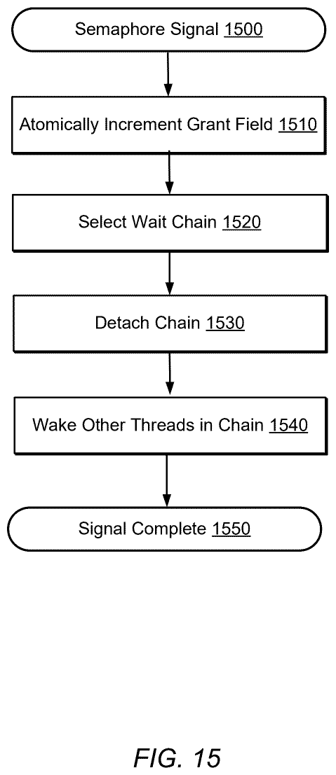

FIG. 15 is a flow diagram illustrating at least one embodiment of a method for implementing a signal operation using a ticket-based semaphore augmented with an array of wait chains. In at least one embodiment, as shown in 1510 a wait field of a desired semaphore, such as Grant 220 of FIG. 2, may be atomically incremented to signal the semaphore.

In at least one embodiment, as shown in 1520, a wait chain may be selected to signal. To select a wait chain, in at least one embodiment one or more hash operations may be used to compute an effective element, such as a Wait Element 1220 identified by a WaitArraySlot 1210 as shown in FIG. 12, of one or more arrays of memory variables. The hash operation may be performed on the allocated ticket value, alone or in combination with other information related to the lock. In some embodiments, the hash may comprise simple modulo operations dependent on the sizes of the one or more waiting arrays with these modulo operations performed on the ticket value itself, alone or as modified by other lock information. In other embodiments, the ticket value may first be modified so as to enable the hash to distribute consecutive ticket values among unique cache lines. For example, the ticket value may first be scaled by a prime number selected to be close to the size of a cache line of the underlying computer architecture. Any number of hash computations or other determination technique may also be employed and it should be understood that the hash computations described above are not intended to be limiting.

In at least one embodiment, as shown in 1530 the thread may then detach the selected wait chain using an atomic operation. Then in at least one embodiment, as shown in 1540 In at least one embodiment, as shown in 1442 the thread may wake other threads in the chain by asserting, or writing a true value to, a notify field, such as the Notified field 1230 as shown in FIG. 12, to a first element in the chain. The method is then complete.

Some of the mechanisms described herein may be provided as a computer program product, or software, that may include a non-transitory, computer-readable storage medium having stored thereon instructions which may be used to program a computer system 2000 (or other electronic devices) to perform a process according to various embodiments. A computer-readable storage medium may include any mechanism for storing information in a form (e.g., software, processing application) readable by a machine (e.g., a computer). The machine-readable storage medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; electrical, or other types of medium suitable for storing program instructions. In addition, program instructions may be communicated using optical, acoustical or other form of propagated signal (e.g., carrier waves, infrared signals, digital signals, etc.)

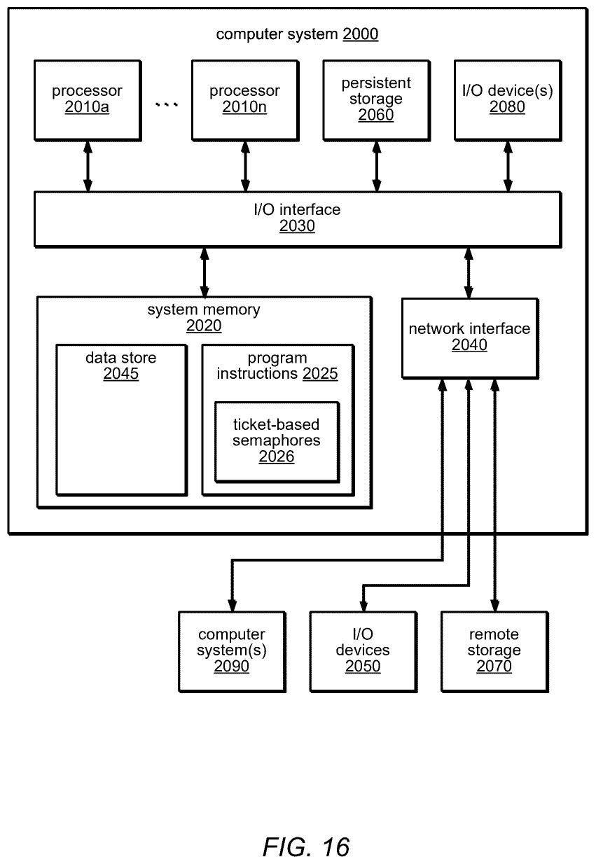

Any of various computer systems may be configured to implement processes associated with a technique for multi-region, multi-primary data store replication as discussed with regard to the various figures above. FIG. 16 is a block diagram illustrating one embodiment of a computer system suitable for implementing some or all of the techniques and systems described herein. In some cases, a host computer system may host multiple virtual instances that implement the servers, request routers, storage services, control systems or client(s). However, the techniques described herein may be executed in any suitable computer environment (e.g., a cloud computing environment, as a network-based service, in an enterprise environment, etc.).

Various ones of the illustrated embodiments may include one or more computer systems 2000 such as that illustrated in FIG. 16 or one or more components of the computer system 2000 that function in a same or similar way as described for the computer system 2000.

In the illustrated embodiment, computer system 2000 includes one or more processors 2010 coupled to a system memory 2020 via an input/output (I/O) interface 2030. Computer system 2000 further includes a network interface 2040 coupled to I/O interface 2030. In some embodiments, computer system 2000 may be illustrative of servers implementing enterprise logic or downloadable applications, while in other embodiments servers may include more, fewer, or different elements than computer system 2000.

Computer system 2000 includes one or more processors 2010 (any of which may include multiple cores, which may be single or multi-threaded) coupled to a system memory 2020 via an input/output (I/O) interface 2030. Computer system 2000 further includes a network interface 2040 coupled to I/O interface 2030. In various embodiments, computer system 2000 may be a uniprocessor system including one processor 2010, or a multiprocessor system including several processors 2010 (e.g., two, four, eight, or another suitable number). Processors 2010 may be any suitable processors capable of executing instructions. For example, in various embodiments, processors 2010 may be general-purpose or embedded processors implementing any of a variety of instruction set architectures (ISAs), such as the x86, PowerPC, SPARC, or MIPS ISAs, or any other suitable ISA. In multiprocessor systems, each of processors 2010 may commonly, but not necessarily, implement the same ISA. The computer system 2000 also includes one or more network communication devices (e.g., network interface 2040) for communicating with other systems and/or components over a communications network (e.g. Internet, LAN, etc.). For example, a client application executing on system 2000 may use network interface 2040 to communicate with a server application executing on a single server or on a cluster of servers that implement one or more of the components of the embodiments described herein. In another example, an instance of a server application executing on computer system 2000 may use network interface 2040 to communicate with other instances of the server application (or another server application) that may be implemented on other computer systems (e.g., computer systems 2090).

System memory 2020 may store instructions and data accessible by processor 2010. In various embodiments, system memory 2020 may be implemented using any suitable memory technology, such as static random-access memory (SRAM), synchronous dynamic RAM (SDRAM), non-volatile/Flash-type memory, or any other type of memory. In the illustrated embodiment, program instructions and data implementing desired functions, such as those methods and techniques as described above for ticket-based semaphores as indicated at 2026, for the downloadable software or provider network are shown stored within system memory 2020 as program instructions 2025. In some embodiments, system memory 2020 may include data store 2045 which may be configured as described herein.

In some embodiments, system memory 2020 may be one embodiment of a computer-accessible medium that stores program instructions and data as described above. However, in other embodiments, program instructions and/or data may be received, sent or stored upon different types of computer-accessible media. Generally speaking, a computer-accessible medium may include computer-readable storage media or memory media such as magnetic or optical media, e.g., disk or DVD/CD-ROM coupled to computer system 2000 via I/O interface 2030. A computer-readable storage medium may also include any volatile or non-volatile media such as RAM (e.g. SDRAM, DDR SDRAM, RDRAM, SRAM, etc.), ROM, etc., that may be included in some embodiments of computer system 2000 as system memory 2020 or another type of memory. Further, a computer-accessible medium may include transmission media or signals such as electrical, electromagnetic, or digital signals, conveyed via a communication medium such as a network and/or a wireless link, such as may be implemented via network interface 2040.

In one embodiment, I/O interface 2030 may coordinate I/O traffic between processor 2010, system memory 2020 and any peripheral devices in the system, including through network interface 2040 or other peripheral interfaces. In some embodiments, I/O interface 2030 may perform any necessary protocol, timing or other data transformations to convert data signals from one component (e.g., system memory 2020) into a format suitable for use by another component (e.g., processor 2010). In some embodiments, I/O interface 2030 may include support for devices attached through various types of peripheral buses, such as a variant of the Peripheral Component Interconnect (PCI) bus standard or the Universal Serial Bus (USB) standard, for example. In some embodiments, the function of I/O interface 2030 may be split into two or more separate components, such as a north bridge and a south bridge, for example. Also, in some embodiments, some or all of the functionality of I/O interface 2030, such as an interface to system memory 2020, may be incorporated directly into processor 2010.

Network interface 2040 may allow data to be exchanged between computer system 2000 and other devices attached to a network, such as between a client device and other computer systems, or among hosts, for example. In particular, network interface 2040 may allow communication between computer system 800 and/or various other device 2060 (e.g., I/O devices). Other devices 2060 may include scanning devices, display devices, input devices and/or other communication devices, as described herein. Network interface 2040 may commonly support one or more wireless networking protocols (e.g., Wi-Fi/IEEE 802.7, or another wireless networking standard). However, in various embodiments, network interface 2040 may support communication via any suitable wired or wireless general data networks, such as other types of Ethernet networks, for example. Additionally, network interface 2040 may support communication via telecommunications/telephony networks such as analog voice networks or digital fiber communications networks, via storage area networks such as Fibre Channel SANs, or via any other suitable type of network and/or protocol.

In some embodiments, I/O devices may be relatively simple or “thin” client devices. For example, I/O devices may be implemented as dumb terminals with display, data entry and communications capabilities, but otherwise little computational functionality. However, in some embodiments, I/O devices may be computer systems implemented similarly to computer system 2000, including one or more processors 2010 and various other devices (though in some embodiments, a computer system 2000 implementing an I/O device 2050 may have somewhat different devices, or different classes of devices).

In various embodiments, I/O devices (e.g., scanners or display devices and other communication devices) may include, but are not limited to, one or more of: handheld devices, devices worn by or attached to a person, and devices integrated into or mounted on any mobile or fixed equipment, according to various embodiments. I/O devices may further include, but are not limited to, one or more of: personal computer systems, desktop computers, rack-mounted computers, laptop or notebook computers, workstations, network computers, “dumb” terminals (i.e., computer terminals with little or no integrated processing ability), Personal Digital Assistants (PDAs), mobile phones, or other handheld devices, proprietary devices, printers, or any other devices suitable to communicate with the computer system 2000. In general, an I/O device (e.g., cursor control device, keyboard, or display(s) may be any device that can communicate with elements of computing system 2000.

The various methods as illustrated in the figures and described herein represent illustrative embodiments of methods. The methods may be implemented manually, in software, in hardware, or in a combination thereof. The order of any method may be changed, and various elements may be added, reordered, combined, omitted, modified, etc. For example, in one embodiment, the methods may be implemented by a computer system that includes a processor executing program instructions stored on a computer-readable storage medium coupled to the processor. The program instructions may be configured to implement the functionality described herein.

Various modifications and changes may be made as would be obvious to a person skilled in the art having the benefit of this disclosure. It is intended to embrace all such modifications and changes and, accordingly, the above description to be regarded in an illustrative rather than a restrictive sense.

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

Embodiments of decentralized application development and deployment as described herein may be executed on one or more computer systems, which may interact with various other devices. FIG. 16 is a block diagram illustrating an example computer system, according to various embodiments. For example, computer system 2000 may be configured to implement nodes of a compute cluster, a distributed key value data store, and/or a client, in different embodiments. Computer system 2000 may be any of various types of devices, including, but not limited to, a personal computer system, desktop computer, laptop or notebook computer, mainframe computer system, handheld computer, workstation, network computer, a consumer device, application server, storage device, telephone, mobile telephone, or in general any type of compute node, computing node, or computing device.

In the illustrated embodiment, computer system 2000 also includes one or more persistent storage devices 2060 and/or one or more I/O devices 2080. In various embodiments, persistent storage devices 2060 may correspond to disk drives, tape drives, solid state memory, other mass storage devices, or any other persistent storage device. Computer system 2000 (or a distributed application or operating system operating thereon) may store instructions and/or data in persistent storage devices 2060, as desired, and may retrieve the stored instruction and/or data as needed. For example, in some embodiments, computer system 2000 may be a storage host, and persistent storage 2060 may include the SSDs attached to that server node.

In some embodiments, program instructions 2025 may include instructions executable to implement an operating system (not shown), which may be any of various operating systems, such as UNIX, LINUX, Solaris™, MacOS™, Windows™, etc. Any or all of program instructions 2025 may be provided as a computer program product, or software, that may include a non-transitory computer-readable storage medium having stored thereon instructions, which may be used to program a computer system (or other electronic devices) to perform a process according to various embodiments. A non-transitory computer-readable storage medium may include any mechanism for storing information in a form (e.g., software, processing application) readable by a machine (e.g., a computer). Generally speaking, a non-transitory computer-accessible medium may include computer-readable storage media or memory media such as magnetic or optical media, e.g., disk or DVD/CD-ROM coupled to computer system 2000 via I/O interface 2030. A non-transitory computer-readable storage medium may also include any volatile or non-volatile media such as RAM (e.g. SDRAM, DDR SDRAM, RDRAM, SRAM, etc.), ROM, etc., that may be included in some embodiments of computer system 2000 as system memory 2020 or another type of memory. In other embodiments, program instructions may be communicated using optical, acoustical or other form of propagated signal (e.g., carrier waves, infrared signals, digital signals, etc.) conveyed via a communication medium such as a network and/or a wireless link, such as may be implemented via network interface 2040.

It is noted that any of the distributed system embodiments described herein, or any of their components, may be implemented as one or more network-based services. For example, a compute cluster within a computing service may present computing services and/or other types of services that employ the distributed computing systems described herein to clients as network-based services. In some embodiments, a network-based service may be implemented by a software and/or hardware system designed to support interoperable machine-to-machine interaction over a network. A network-based service may have an interface described in a machine-processable format, such as the Web Services Description Language (WSDL). Other systems may interact with the network-based service in a manner prescribed by the description of the network-based service's interface. For example, the network-based service may define various operations that other systems may invoke and may define a particular application programming interface (API) to which other systems may be expected to conform when requesting the various operations.

In various embodiments, a network-based service may be requested or invoked through the use of a message that includes parameters and/or data associated with the network-based services request. Such a message may be formatted according to a particular markup language such as Extensible Markup Language (XML), and/or may be encapsulated using a protocol such as Simple Object Access Protocol (SOAP). To perform a network-based services request, a network-based services client may assemble a message including the request and convey the message to an addressable endpoint (e.g., a Uniform Resource Locator (URL)) corresponding to the network-based service, using an Internet-based application layer transfer protocol such as Hypertext Transfer Protocol (HTTP).

In some embodiments, network-based services may be implemented using Representational State Transfer (“RESTful”) techniques rather than message-based techniques. For example, a network-based service implemented according to a RESTful technique may be invoked through parameters included within an HTTP method such as PUT, GET, or DELETE, rather than encapsulated within a SOAP message.

Although the embodiments above have been described in considerable detail, numerous variations and modifications may be made as would become apparent to those skilled in the art once the above disclosure is fully appreciated. It is intended that the following claims be interpreted to embrace all such modifications and changes and, accordingly, the above description to be regarded in an illustrative rather than a restrictive sense.

What is claimed:

1. A computer-implemented method, comprising:
waiting for a semaphore, by a thread of a plurality of threads executing on one or more processors, comprising:
executing an atomic fetch-and-add operation to allocate a waiting position for the semaphore; and
waiting until a difference value indicates that waiting for the semaphore is complete, the difference value determined as a difference between the waiting position and a grant value of the semaphore.

2. The computer-implemented method of claim 1, further comprising signaling the semaphore by the thread executing on the one or more processors, comprising:
atomically incrementing the grant value of the semaphore.

3. The computer-implemented method of claim 1, wherein waiting until the difference value indicates that waiting for the semaphore is complete further comprises:
determining, prior to waiting until the difference value indicates that waiting for the semaphore is complete and according to the allocated waiting position and the grant value, that a number of threads of the plurality of threads waiting for the semaphore exceeds a threshold, and responsive to the determining:
selecting a location of a long term wait value, the location different from a location of the grant value; and
waiting for the long term wait value to indicate that the number of threads waiting for the semaphore no longer exceeds the threshold.

4. The computer-implemented method of claim 3, further comprising signaling the semaphore by the thread executing on the one or more processors, comprising:
atomically incrementing the grant value of the semaphore;
selecting the location of the long term wait value; and
updating the long term wait value to indicate that the number of threads waiting for the semaphore no longer exceeds the threshold.

5. The computer-implemented method of claim 3:
wherein waiting until the difference value indicates that waiting for the semaphore is complete comprises spinning on the grant value of the semaphore; and
wherein waiting for the long term wait value to indicate that the number of threads waiting for the semaphore no longer exceeds the threshold yielding until the long term wait value is updated.

6. The computer-implemented method of claim 3, wherein selecting the location of the long term wait value comprises:
selecting the location from a plurality of wait locations based at least in part on a result of a hash operation performed on the value of the allocated waiting position.

7. The computer-implemented method of claim 6, wherein the one or more processors respectively comprise one or more memory caches, and wherein the hash operation performed on the value of the allocated waiting position comprises distributing consecutive values of waiting positions to respective wait locations associated with respective different cache lines.

8. One or more non-transitory computer-accessible storage media storing program instructions that when executed on or across one or more processors cause the one or more processors to perform:
waiting for a semaphore, by a thread of a plurality of threads executing on one or more processors, comprising:
executing an atomic fetch-and-add operation to allocate a waiting position for the semaphore; and
waiting until a difference value indicates that waiting for the semaphore is complete, the difference value determined as a difference between the waiting position and a grant value of the semaphore.

9. The one or more non-transitory computer-accessible storage media of claim 8, the one or more processors caused to perform signaling the semaphore by the thread executing on the one or more processors, comprising:
atomically incrementing the grant value of the semaphore.

10. The one or more non-transitory computer-accessible storage media of claim 8, wherein waiting until the difference value indicates that waiting for the semaphore is complete further comprises:
determining, prior to waiting until the difference value indicates that waiting for the semaphore is complete and according to the allocated waiting position and the grant value, that a number of threads of the plurality of threads waiting for the semaphore exceeds a threshold, and responsive to the determining:
selecting a location of a long term wait value, the location different from a location of the grant value; and
waiting for the long term wait value to indicate that the number of threads waiting for the semaphore no longer exceeds the threshold.

11. The one or more non-transitory computer-accessible storage media of claim 10, the one or more processors caused to perform signaling the semaphore by the thread executing on the one or more processors, comprising:
atomically incrementing the grant value of the semaphore;
selecting the location of the long term wait value; and
updating the long term wait value to indicate that the number of threads waiting for the semaphore no longer exceeds the threshold.

12. The one or more non-transitory computer-accessible storage media of claim 10:
wherein waiting until the difference value indicates that waiting for the semaphore is complete comprises spinning on the grant value of the semaphore; and
wherein waiting for the long term wait value to indicate that the number of threads waiting for the semaphore no longer exceeds the threshold yielding until the long term wait value is updated.

13. The one or more non-transitory computer-accessible storage media of claim 10, wherein selecting the location of the long term wait value comprises:
selecting the location from a plurality of wait locations based at least in part on a result of a hash operation performed on the value of the allocated waiting position.

14. The one or more non-transitory computer-accessible storage media of claim 13, wherein the one or more processors respectively comprise one or more memory caches, and wherein the hash operation performed on the value of the allocated waiting position comprises distributing consecutive values of waiting positions to respective wait locations associated with respective different cache lines.

15. A system, comprising:
one or more processors and a memory, the memory comprising program instructions executable by the one or more processors to wait for a semaphore by a thread of a plurality of threads, wherein to wait for the semaphore the thread is configured to:
execute an atomic fetch-and-add operation to allocate a waiting position for the semaphore; and
wait until a difference value indicates that waiting for the semaphore is complete, the difference value determined as a difference between the waiting position and a grant value of the semaphore.

16. The system of claim 15, wherein the program instructions are further executable by the one or more processors to signal the semaphore by the thread executing on the one or more processors, wherein to signal the semaphore the thread is configured to:
atomically increment the grant value of the semaphore.

17. The system of claim 15, wherein to wait until the difference is greater than zero the thread is configured to:
determine, prior to waiting until the difference value indicates that waiting for the semaphore is complete and according to the allocated waiting position and the grant value, that a number of threads of the plurality of threads waiting for the semaphore exceeds a threshold, and responsive to the determining:
select a location of a long term wait value, the location different from a location of the grant value; and
wait for the long term wait value to indicate that the number of threads waiting for the semaphore no longer exceeds the threshold.

18. The system of claim 16, wherein the program instructions are further executable by the one or more processors to signal the semaphore by the thread executing on the one or more processors, wherein to signal the semaphore the thread is configured to:
atomically increment the grant value of the semaphore;
select the location of the long term wait value; and
update the long term wait value to indicate that the number of threads waiting for the semaphore no longer exceeds the threshold.

19. The system of claim 16:
wherein waiting until the difference value indicates that waiting for the semaphore is complete comprises spinning on the grant value of the semaphore; and
wherein waiting for the long term wait value to indicate that the number of threads waiting for the semaphore no longer exceeds the threshold yielding until the long term wait value is updated.

20. The system of claim 15, wherein to select the location of the long term wait value the thread is configured to:
select the location from a plurality of wait locations based at least in part on a result of a hash operation performed on the value of the allocated waiting position, wherein the one or more processors respectively comprise one or more memory caches, and wherein the hash operation performed on the value of the allocated waiting position comprises distributing consecutive values of waiting positions to respective wait locations associated with respective different cache lines.
